(19) United States
(12) Patent Application Publication
(10) Pub. No.: US 2003/0234516 A1
(43) Pub. Date: Dec. 25, 2003

(54) Light and sound producing structure for wheeled traveling case assembly

(76) Inventor: Angela W. Han, Taipei (TW)

Correspondence Address: LAW OFFICE OF LIAUH & ASSOC., 4224 WAIALAE AVE, STE 5-388, HONOLULU, HI, 96816

(21) Appl. No.: 10/342,900

(22) Filed: Jan. 14, 2003

Related U.S. Application Data
(63) Continuation-in-part of application No. 10/177,959, filed on Jun. 20, 2002.

(51) Int. Cl. B62B 1/00

(52) U.S. Cl. 280/655

(57) ABSTRACT

A light and sound producing structure for a wheeled traveling case assembly having a base with two wheels, an extendable pull handle and two front legs connected thereto, and a traveling case located on the front legs mainly includes a ring-shaped magnetic rotor fixedly mounted on an axle of one of the two wheels to rotate along with the wheel, and a stator coil fixedly mounted on the base to surround the ring-shaped magnetic rotor. When the wheels rotate, induced currents are generated on the stator coil and supplied to the pull handle and/or the traveling case for light-emitting and sound-reproducing elements provided thereon to produce light and sound, respectively.

This application is a continuation in part of U.S. Pat. application Ser. No. 10/177,959 filed on Jun. 20, 2002.

### FIELD OF THE INVENTION

The present invention relates to a light and sound producing structure for wheeled traveling case assembly. When two wheels of the traveling case assembly rotate, induced currents are generated and supplied to light-emitting and sound-reproducing elements provided on handle grip and traveling case of the traveling case assembly, so that the light-emitting and sound-reproducing elements give light and sound, respectively.

### BACKGROUND OF THE INVENTION

Consumers tend to select durable, multi-functional, and attractive products. Products meeting these conditions are particularly welcomed among children, teenagers, and adults who are still retaining child's innocence.

The design idea of wheeled traveling case assembly has also been employed in satchels. Schoolchildren may now pull a wheeled satchel while walking easily without the need of laboriously carrying heavy books on backs.

The reduced visibility in the night prevents people from quickly perceiving objects within a short time. That is why most accidents occur in the night. However, people are sensitive to light in the dark. That is, people have the ability of quickly and clearly noticing a light source in the night. Since children are not aware of and do not respond to suddenly occurred dangers quickly, shoes with light emitting device are developed for children for them to wear and walk in the night safely. When a wearer walks, such shoes emit light as a warning to car drivers to avoid accidents. U.S. Pat. Nos. 4,848,009; 5,477,435; 5,303,485; and 5,758,946 all disclose shoes with light emitting device.

It is very frequent that a user pulls or pushes a wheeled traveling case assembly along or across a road in the night. The heavily loaded wheeled traveling case would usually distract the user when he or she crosses the road at inevitably slowed speed. An accident occurs if a car rushed by and did not notice someone is walking along or across the road.

### SUMMARY OF THE INVENTION

It is a primary object of the present invention to provide a light and sound producing structure for wheeled traveling case assembly, so that currents are generated when wheels of the traveling case assembly rotate. The generated currents are supplied to light-emitting and sound-reproducing elements mounted on the wheeled traveling case assembly for them to give light and sound, respectively. The wheeled traveling case assembly is therefore more attractive for use and helpful in ensuring the user's safety when he or she moves along or across a road in the night.

In the light and sound producing structure for wheeled traveling case assembly according to the present invention, at least one of the two wheels of the traveling case assembly is provided at an inner side with an annular recess for a ring-shaped magnetic rotor to fixedly mounted on an inner circumferential surface thereof to rotate along with the wheel, and a stator coil is fixedly mounted on a base of the traveling case assembly to surround the ring-shaped magnetic rotor. Thus, when the wheels rotate, induced currents are generated on the stator coil and supplied to the light-emitting and sound-reproducing elements mounted on the wheeled traveling case assembly for them to give light and sound, respectively.

In the light and sound producing structure for wheeled traveling case assembly according to the present invention, the light-emitting and sound-reproducing elements may be provided on a handle grip of a pull handle and/or an outer surface of a traveling case of the wheeled traveling case assembly.

In the light and sound producing structure for wheeled traveling case assembly according to the present invention, the light-emitting elements provided on the handle grip and the traveling case of the wheeled traveling case assembly are coated with a transparent waterproof material that does not hinder transmission of light emitted from the light-emitting elements.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a rear perspective view of a wheeled traveling case assembly incorporating a light and sound producing structure of the present invention;

FIG. 2 is a fragmentary sectional view showing the connection of a wheel to a base of the wheeled traveling case assembly of FIG. 1;

FIG. 3 is a fragmentary sectioned view showing a handle grip for the wheeled traveling case assembly of FIG. 1;

FIG. 4 shows conducting wires are provided in a pull handle of the wheeled traveling case assembly of FIG. 1; and

FIG. 5 shows light-emitting and sound-reproducing elements are provided on a traveling case of the wheeled traveling case assembly of FIG. 1.

### DETAILED DESCRIPTION OF THE PREFERRED EMBODIMENTS

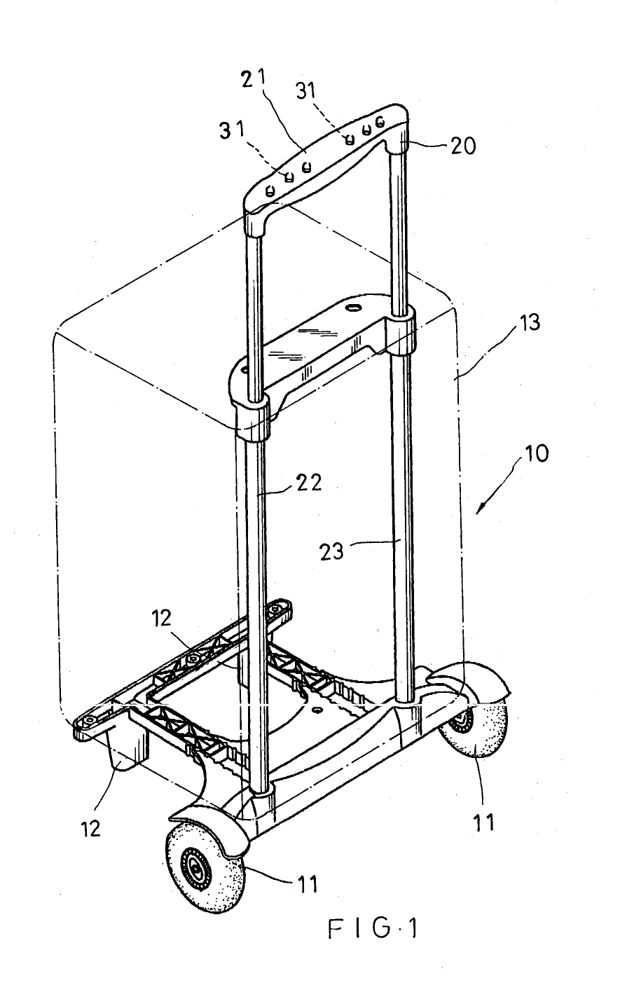

Please refer to FIG. 1 that is a rear perspective view of a wheeled traveling case assembly 10 incorporating a light and sound producing structure of the present invention. As shown, the wheeled traveling case assembly 10 includes a base 16 and a traveling case 13. To the base 16, left and right wheels 11, an extendable pull handle 20, and two front supporting legs 12 are connected. The front supporting legs 12 forward extend from a lower front of the pull handle 20 to enable the wheeled traveling case assembly 10 to stand stably, and the traveling case 13 is located on the two front supporting legs 12. The pull handle 20 includes left and right metal supporting bars 22 and 23, respectively, and a handle grip 21 transversely connected to upper ends of the two supporting bars 22, 23.

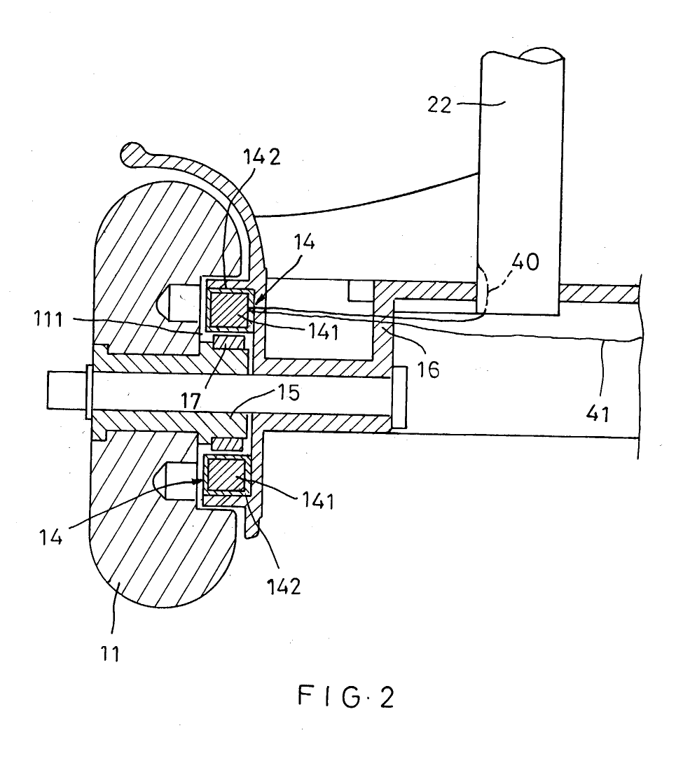

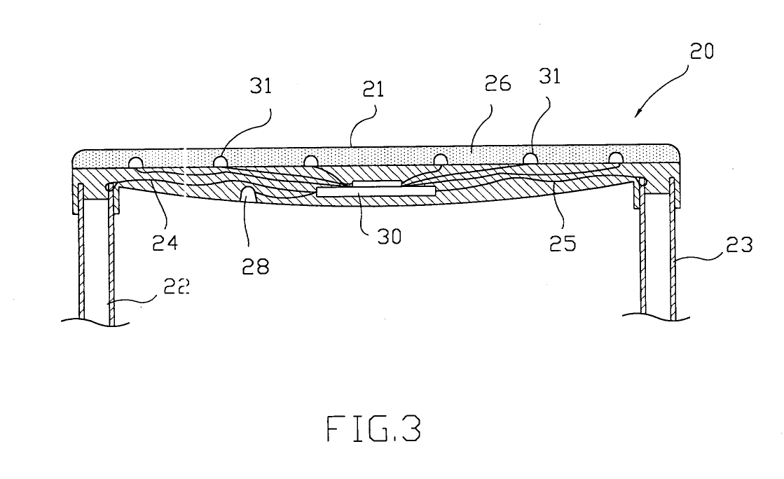

Please refer to FIGS. 1 to 5 at the same time. A circuit board 30, a plurality of light-emitting elements 31, and a sound-reproducing element 28 are internally provided in the handle grip 21 (see FIG. 3). At least one of the left and right wheels 11, which is the left wheel in the illustrated drawings, has a ring-shaped magnetic rotor 17 fixedly mounted on an axle 15 thereof, and a stator coil 14 is fixedly mounted on the base 16 to surround the ring-shaped magnetic rotor 17 (see FIG. 2). The stator coil 14 includes a coil 141 and a magnetic conducting element 142. When the wheels 11 rotate, the ring-shaped magnetic rotor 17 mounted on the at least one of the two wheels 11 synchronously rotates in the center of the stator coil 14, resulting in the generation of induced currents on the coil 141. The induced currents are supplied to the handle grip 21 for the light-emitting elements 31 and the sound-reproducing element 28 to emit light and reproduce sound, respectively.

Positive and negative electrodes of the coil 141 are connected to left and right metal supporting bars 22 and 23, respectively, of the pull handle 20 via conducting wire 40 and 41, and the two metal supporting bars 22 and 23 are further electrically connected to the circuit board 30 in the handle grip 21 via another two conducting wires 24, 25, as shown in FIG. 3.

When the wheels 11 rotate, induced currents are generated on the coil 141, as explained in the above paragraphs. The induced currents are supplied via the left and the right metal supporting bars 22, 23 of the pull handle 20 and the conducting wires 24, 25 to the light-emitting elements 31 and the sound-reproducing element 28 in the handle grip 21 for them to emit light and reproduce sound, respectively.

As can be seen from FIG. 2, the wheel 11 is provided at an inner side with an annular recess 111. The ring-shaped magnetic rotor 17 is fixedly mounted on an inner circumferential surface of the annular recess 111, such that the ring-shaped magnetic rotor 17 and the wheel 11 rotate synchronously. The stator coil 14 fixed on the base 16 sideward extends into the annular recess 111 to surround the ring-shaped magnetic rotor 17. These arrangements allow providing of current generating means on the wheeled traveling case assembly of the present invention without increasing a space between the wheel 11 and the base 16.

The wheeled traveling case assembly 10 equipped with wheels 11 is usually pulled forward with the wheels 11 rolling on a ground surface. Therefore, the rolling wheel 11 functions like a generator to generate induced currents. That is, currents needed by the light-emitting elements 31 and the sound-reproducing element 28 on the handle grip 21 to emit light and reproduce sound can be supplied by the rolling wheels 11. Therefore, it is possible for the wheeled traveling case assembly 10 to emit light and sound simply by pulling it in a general manner of use without the need of any battery or other power source. The light and sound producing structure of the present invention for a wheeled traveling case assembly is therefore an economical and environmentally friendly design.

The light-emitting elements 31 on the handle grip 21 are coated with a waterproof transparent material 26 that allows light emitted by the light-emitting elements 31 to pass therethrough. The circuit board 30 in the handle grip 21 may be provided with a chip (not shown) to control the light-emitting elements 31 to emit light in different modes. For example, the light-emitting elements 31 may be caused to flash simultaneously or alternately. Since such circuit design is a prior art, it is not discussed in details herein. In an embodiment of the present invention, the light-emitting elements 31 are small bulbs.

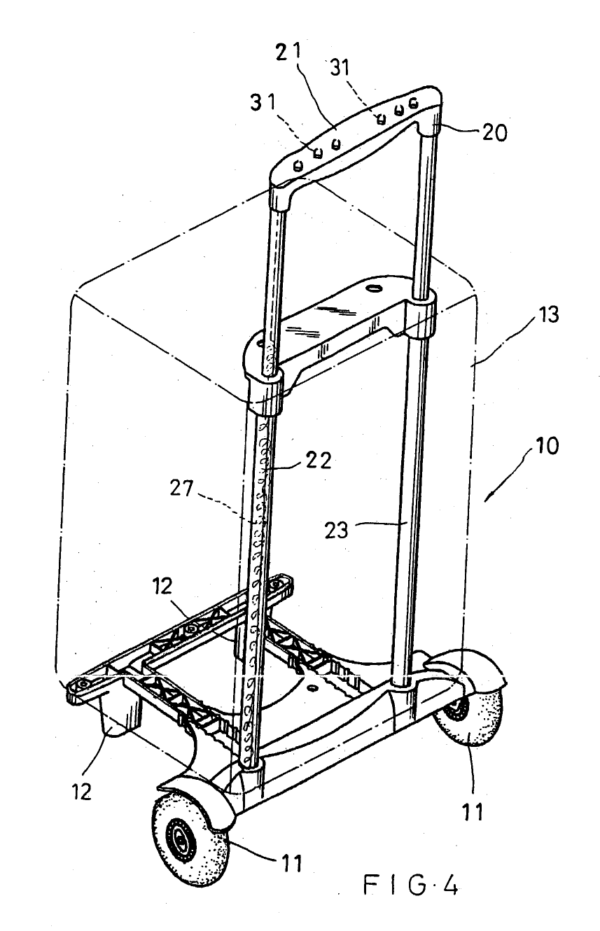

Please refer to FIG. 4. The coil 141 may be otherwise connected to the circuit board 30 in the handle grip 21 via spiral wires 27 concealed in the supporting bar 22 of the pull handle 20. When the extendable pull handle 20 is extended or telescoped, the spiral wires 27 are adapted to stretch or compress correspondingly. Moreover, the sound-reproducing element 28 may reproduce one or more preset pieces of music or other types of sounds when it is electrically made.

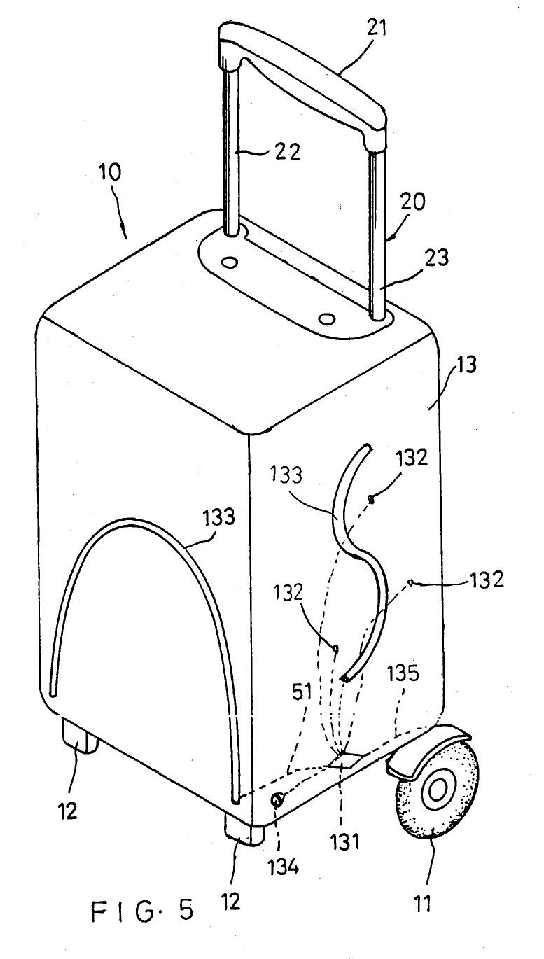

Please refer to FIG. 5. A circuit board 131, and light-emitting elements 132, 133 and a sound-reproducing element 134 connected to the circuit board 131 may be provided on the traveling case 13. The circuit board 131 is electrically connected via a concealed conducting wire 135 to the positive and negative electrodes of the coil 141. And, the light-emitting elements 132, 133 may be small bulbs lighting tubes.

The light and sound producing structure for wheeled traveling case assembly according to the present invention enables light and sound to emit from the handle grip and the traveling case on the wheeled traveling case assembly when a user moves the latter in a most natural and ordinary manner, making the wheeled traveling case assembly not only a highly interesting and attractive product, but also a product highly effective in helping the user to safely move along or across a road in the night.

What is claimed is:

1. A light and sound producing structure for wheeled traveling case assembly, said wheeled traveling case assembly including a base having left and right wheels, an extendable pull handle, and two front supporting legs connected thereto, and a traveling case located on said two front supporting legs, and said pull handle including left and right metal supporting bars and a handle grip transversely connected to upper ends of said two supporting bars, comprising:
at least one circuit board, a plurality of light-emitting elements, and at least one sound-reproducing element provided on said wheeled traveling case assembly and protectively coated with a waterproof material;
first conducting wires electrically connecting said at least one circuit board to said plurality of light-emitting elements and said at least one sound-reproducing element;
a ring-shaped magnetic rotor fixedly mounted on an axle of at least one of said left and right wheels;
a stator coil fixedly mounted on said base to surround said ring-shaped magnetic rotor; and
conductors or second conducting wires electrically connecting positive and negative electrodes of said stator coil to said at least one circuit board;
whereby when said wheels rotate, said ring-shaped magnetic rotor synchronously rotates in a center of said stator coil to result in generation of induced currents on said stator coil, and said induced currents are supplied via said conductor or said second conducting wires to said at least one circuit board for said light-emitting elements and said sound-reproducing element to emit light and reproduce sound, respectively.

2. The light and sound producing structure for wheeled traveling case assembly as claimed in claim 1, wherein said at least one of said left and right wheels is provided at an inner side with an annular recess, said ring-shaped magnetic rotor being fixedly mounted to an inner circumferential surface of said annular recess, and said stator coil on said base being sideward extended into said annular recess to surround said ring-shaped magnetic rotor.

3. The light and sound producing structure for wheeled traveling case assembly as claimed in claim 1, wherein said waterproof material coating said light-emitting elements comprises a light transmissible material.

4. The light and sound producing structure for wheeled traveling case assembly as claimed in claim 1, wherein said light-emitting elements and said at least one sound-reproducing element are provided on said handle grip of said pull handle.

5. The light and sound producing structure for wheeled traveling case assembly as claimed in claim 1, wherein said light-emitting elements and said at least one sound-reproducing element are provided on an outer surface of said traveling case.

6. The light and sound producing structure for wheeled traveling case assembly as claimed in claim 1, wherein said light-emitting elements comprise small bulbs.

7. The light and sound producing structure for wheeled traveling case assembly as claimed in claim 1, wherein said light-emitting elements comprise lighting tubes.

8. The light and sound producing structure for wheeled traveling case assembly as claimed in claim 1, wherein said conductors connecting said stator coil to said at least one circuit board are said left and right metal supporting bars of said pull handle.

9. The light and sound producing structure for wheeled traveling case assembly as claimed in claim 1, wherein said second conducting wires connecting said stator coil to said at least one circuit board are spiral wires.
